(19) United States
(12) Patent Application Publication
(10) Pub. No.: US 2026/0276885 A1
(43) Pub. Date: Sep. 17, 2026

(54) SEMICONDUCTOR STRUCTURE AND METHOD FOR MANUFACTURING THE SAME

(71) Applicant: SHANGHAI XIZHI TECHNOLOGY CO., LTD, Shanghai (CN)

(72) Inventors: Yichen SHEN, Shanghai (CN); Huaiyu MENG, Shanghai (CN); Yelong XU, Shanghai (CN); Setiadi DADI, Shanghai (CN); Bo PENG, Shanghai (CN); Jayachandran SUSEENDRAN, Shanghai (CN); Zhan SU, Shanghai (CN); Jianhua WU, Shanghai (CN)

(21) Appl. No.: 19/168,457

(22) PCT Filed: Mar. 15, 2024
(86) PCT No.: PCT/CN2024/081824

§ 371 Date: Sep. 24, 2025

(30) Foreign Application Priority Data
Mar. 28, 2023 (CN) 202310316544.8

(51) Int. Cl. G02B 6/12; G02B 6/124; G02B 6/13

(52) U.S. Cl. CPC G02B 6/12004; G02B 6/124; G02B 6/13

(57) ABSTRACT

The present invention relates to semiconductor technology and provides a semiconductor structure employing optical interconnects and a method for manufacturing the same. The structure comprises: a photonic wafer carrying a plurality of photonic integrated circuit (PIC) chips, each having a first waveguide; an optical interposer carrying the photonic wafer and including a second waveguide; a plurality of analog electrical chips, each connected to at least one PIC chip; and a plurality of digital electrical chips, each electrically connected to a corresponding analog electrical chip. On the optical interposer, PIC chips arranged in a first direction are optically connected through the first waveguides, and PIC chips arranged in a second direction are optically connected through the second waveguides. This configuration enables integration of more computing and storage units, with optical interconnects providing seamless data exchange and improved system energy efficiency.

### CROSS-REFERENCE TO RELATED APPLICATION(S)

This application claims the benefit of and priority to Chinese Invention Patent Application No. 2023103165448, titled “Semiconductor Structure and Manufacturing Method Thereof”, filed on Mar. 28, 2023. The entire contents of the application are incorporated herein by reference.

### FIELD OF THE INVENTION

The present invention relates generally to the field of semiconductor technology, and more particularly, to a semiconductor structure and a method for manufacturing the same.

### BACKGROUND OF THE INVENTION

Very Large Scale Integration (VLSI) circuit technology has become a cornerstone supporting the development and evolution of the information society. Various electronic integrated circuit chips widely used in information systems generally rely on advanced manufacturing processes to achieve performance improvements and power consumption optimization. However, as electronic integrated circuit chip technology approaches its physical limits, the progress of Moore's Law has slowed, and further advancements require new innovations.

One approach to enhance overall chip performance is to integrate multiple electronic integrated circuit chips into existing packaging types, such as 2.5D/3D, fan-out, or multi-chip modules (MCMs). However, the feasibility of the interconnect architectures between electrical chips is often constrained by the performance, availability, and power consumption of inter-chip interconnects. Traditional information interconnects rely on copper conductors for electrical signal transmission. The speed and distance of electronical signal transmission are limited by RC time constants and electrical losses, which in turn require larger copper wire diameter as the speed and distance increase. Additionally, signal crosstalk between electronic channels further limits energy efficiency and bandwidth density of interconnect.

Consequently, the power consumption and bandwidth density limitations of electrical interconnections between chips hinder the development of higher-performance chip systems. Furthermore, traditional electrical interconnect interfaces are highly sensitive to distance, thereby limiting the interconnect architectures between digital electrical chips.

### SUMMARY OF THE INVENTION

To overcome the deficiencies of the aforementioned electrical interconnect technology, the present invention provides a semiconductor structure employing optical interconnects and a method for manufacturing the same.

In one aspect, an embodiment of the present invention provides a semiconductor structure, comprising:
a photonic wafer comprising a plurality of photonic integrated circuit (PIC) chips, each PIC chip including a first waveguide;
an optical interposer on which the photonic wafer is mounted, the optical interposer including a second waveguide;
a plurality of analog electrical chips, each PIC chip being connected to at least one of the analog electrical chips, such that the plurality of analog electrical chips are enabled to optically communicate with each other via the PIC chips and/or the optical interposer; and
a plurality of digital electrical chips, each digital electrical chip being electrically connected to a corresponding analog electrical chip, such that the plurality of digital electrical chips are enabled to communicate with each other via the analog electrical chips through the PIC chips and/or the optical interposer;
wherein, on the optical interposer, PIC chips arranged in a first direction are optically connected through the first waveguides, and PIC chips arranged in a second direction are optically connected through the second waveguide of the optical interposer, the first direction being different from the second direction.

In some embodiments, the PIC chips are fabricated by exposure using a full-mask reticle.

In some embodiments, each PIC chip comprises a stitching coupler oriented along the first direction. The first waveguides of two adjacent PIC chips in the first direction are aligned via the stitching coupler. In some embodiments, the coupling end of the stitching coupler on the PIC chip is structured to gradually expand toward the edge of the PIC chip, i.e., toward the edge of the coupling end.

In some embodiments, the optical interposer comprises a plurality of optical interposer modules, wherein the optical interposer modules are fabricated by exposure using a full-mask reticle. In some embodiments, each optical interposer module comprises a stitching coupler oriented along the second direction. The second waveguides of two adjacent optical interposer modules in the second direction are aligned via the stitching coupler. In some embodiments, the coupling end of the stitching coupler on the optical interposer module is structured to gradually expand toward the edge of the module, i.e., toward the edge of the coupling end.

In some embodiments, each PIC chip comprises a communication node for communicating with a corresponding analog electrical chip, the communication node comprising an electro-optical conversion module and an opto-electrical conversion module. In some embodiments, the electro-optical conversion module comprises a modulator or a modulator array, configured to modulate information carried by electrical signals from the analog electrical chip onto optical signals transmitted via the PIC chip; the opto-electrical conversion module comprises a detector or a detector array, configured to convert optical signals from the PIC chip into electrical signals to be sent to the analog electrical chip.

In some embodiments, each PIC chip comprises a grating coupler or an edge coupler. The grating coupler or edge coupler is optically connected to the modulator or modulator array of the plurality of PIC chips arranged in the first direction via the first waveguide, so as to couple optical signals generated by an external laser module into the plurality of PIC chips.

In some embodiments, each PIC chip further comprises a third waveguide for optical communication, the third waveguide optically connecting the electro-optical conversion module and the opto-electrical conversion module to the first and second waveguides. In some embodiments, the third waveguide is optically coupled to the first and second waveguides, respectively, via an evanescent wave coupler.

In some embodiments, two of the analog electrical chips and one of the digital electrical chips are disposed on each PIC chip, the digital electrical chip being electrically connected to the two analog electrical chips.

In some embodiments, the semiconductor structure further comprises a substrate, on which the optical interposer is mounted.

In some embodiments, the semiconductor structure further comprises a printed circuit board (PCB) and a plurality of vertical power supply devices. The PCB has a first surface and an opposite second surface. The substrate is mounted on the first surface, and the plurality of vertical power supply devices are mounted on the second surface. Each vertical power supply device is located at a position on the second surface vertically corresponding to one of the analog electrical chips or digital electrical chips, and electrically connected to the corresponding chip via PCB metal traces and conductive structures formed in through-holes of the optical interposer and the PIC chips.

In some embodiments, the semiconductor structure further comprises a vertical cooling device disposed above the plurality of analog electrical chips and the plurality of digital electrical chips. In some embodiments, the vertical cooling device comprises a liquid cooling plate in contact with the surfaces of the analog electrical chips and the digital electrical chips. The liquid cooling plate comprises a plurality of cooling channels oriented perpendicular to the surfaces of the analog electrical chips and the digital electrical chips, and a cooling fluid accommodated in the cooling channels.

In another aspect, an embodiment of the present invention provides a method for manufacturing a semiconductor structure, comprising:
providing a photonic wafer comprising a plurality of photonic integrated circuit (PIC) chips, each PIC chip including a first waveguide;
providing an optical interposer on which the photonic wafer is disposed, the optical interposer including a second waveguide;
providing a plurality of analog electrical chips, each PIC chip being connected to at least one of the analog electrical chips such that the plurality of analog electrical chips are enabled to optically communicate with each other via the PIC chips and/or the optical interposer;
providing a plurality of digital electrical chips, each digital electrical chip being electrically connected to a corresponding analog electrical chip, such that the plurality of digital electrical chips are enabled to communicate with each other via the analog electrical chips through the PIC chips and/or the optical interposer;
wherein, on the optical interposer, PIC chips arranged in a first direction are optically connected through the first waveguides, and PIC chips arranged in a second direction are optically connected through the second waveguides, the first direction being different from the second direction.

In some embodiments, the PIC chips are fabricated by exposure using a full-mask reticle.

In some embodiments, each PIC chip comprises a stitching coupler oriented along the first direction. The first waveguides of two adjacent PIC chips in the first direction are aligned via the stitching coupler.

In some embodiments, the optical interposer comprises a plurality of optical interposer modules, each optical interposer module being fabricated by exposure using a full-mask reticle. In some embodiments, each optical interposer module comprises a stitching coupler oriented along the second direction. The second waveguides of two adjacent optical interposer modules in the second direction are aligned via the stitching coupler. In some embodiments, the stitching coupler includes a coupling end that is structured to gradually expand toward the edge thereof.

In some embodiments, each PIC chip comprises a communication node for communicating with a corresponding analog electrical chip, the communication node comprising an electro-optical conversion module and an opto-electrical conversion module.

In some embodiments, each PIC chip further comprises a third waveguide for optical communication. The third waveguide optically connects the electro-optical conversion module and the opto-electrical conversion module to the first and second waveguides. In some embodiments, the third waveguide is optically coupled to the first and second waveguides, respectively, via an evanescent wave coupler.

In some embodiments, two of the analog electrical chips and one of the digital electrical chips are disposed on each PIC chip, the digital electrical chip being electrically connected to the two analog electrical chips.

In some embodiments, the method further comprises providing a substrate and mounting the optical interposer on the substrate.

In some embodiments, the method further comprises providing a printed circuit board (PCB) and a plurality of vertical power supply devices. The PCB has a first surface and an opposite second surface, the substrate is mounted on the first surface, and the plurality of vertical power supply devices are mounted on the second surface. Each vertical power supply device is located at a position on the second surface vertically corresponding to one of the analog electrical chips or digital electrical chips, and electrically connected to the corresponding chip via PCB metal traces and conductive structures formed in through-holes of the optical interposer and the PIC chips.

In some embodiments, the method further comprises providing a vertical cooling device and disposing the vertical cooling device above the plurality of analog electrical chips and the plurality of digital electrical chips. In some embodiments, the vertical cooling device comprises a liquid cooling plate in contact with the surfaces of the analog electrical chips and the digital electrical chips. The liquid cooling plate comprises a plurality of cooling channels oriented perpendicular to the surfaces of the analog electrical chips and the digital electrical chips, and a cooling fluid accommodated in the cooling channels.

According to various embodiments of the present invention, electrical chips are interconnected via a photonic wafer including multiple PIC chips and an optical interposer, thereby overcoming the bottlenecks of power consumption and bandwidth density associated with interconnections among digital electrical chips. When the package structure of the present invention is applied to artificial intelligence chips, a higher system energy efficiency ratio can be achieved. Furthermore, by separating the analog and digital electrical chips onto two different chips, each type of chip can be optimized under its respective fabrication process, while also addressing the slower iteration cycle of analog chips and improving the overall system yield.

In the embodiments of the present invention, the photonic wafer with multiple PIC chips and the optical interposer serve as an intermediary to connect electrical chips. By providing interconnect waveguides in the first and second directions respectively on the PIC chips and the optical interposer, same-layer waveguide crossings are significantly reduced, thereby minimizing optical power loss caused by such crossings. Moreover, because the first-direction waveguides and the second-direction waveguides are formed independently on different layers, the number of masks required is greatly reduced, enabling the realization of ultra-large-scale, fully connected optoelectronic computing systems.

In the embodiments of the present invention, multiple analog electrical chips and multiple digital electrical chips are interconnected through a photonic wafer comprising multiple PIC chips of full-reticle size. This approach not only improves system energy efficiency, but also overcomes the mask size limitation of semiconductor chips, thereby effectively increasing the total chip area available for digital electrical chips and enhancing the overall computational throughput of the optoelectronic computing system employing the packaging structure of the invention.

In the embodiments of the present invention, by employing multiple identical analog electrical chips, multiple digital electrical chips can achieve point-to-point full-mesh connectivity in both horizontal and vertical directions through the PIC chips and the optical interposer. This enables the digital electrical chips to perform parallel information processing simultaneously, while maintaining tightly coupled inter-chip information exchange, thereby better satisfying the computing power and bandwidth requirements of artificial intelligence algorithms. Compared with conventional AI computing systems, an optoelectronic computing system employing the semiconductor structure of the present invention can integrate a larger number of computing and storage units. Moreover, by using optical interconnects to ensure seamless information exchange among these units, the system achieves a significantly higher energy-efficiency ratio.

In summary, compared with electrical interconnects, optical interconnects offer advantages such as higher bandwidth, lower latency, reduced power consumption, higher integration density, and improved resistance to electromagnetic interference. Furthermore, optical interconnects are not sensitive to transmission distance, allowing the transmission of larger volumes of data over longer distances and enabling greater flexibility in computer architecture design.

Various aspects, features, and advantages of the embodiments of the present invention will be described in greater detail in conjunction with the accompanying drawings. Based on the following detailed description and the drawings, the aforementioned aspects, features, and advantages of the present invention will become more apparent.

### BRIEF DESCRIPTION OF THE DRAWINGS

FIG. 1 is a schematic plan view of a semiconductor structure according to an embodiment of the present invention.

FIG. 2 is an enlarged view of a portion of the plan structure of the semiconductor structure shown in FIG. 1.

FIG. 3 is a partial cross-sectional view of the semiconductor structure shown in FIG. 1.

FIG. 4 is a schematic diagram illustrating a stitching coupler for waveguide alignment in a photonic integrated circuit chip according to an embodiment of the present invention.

FIG. 5 is a schematic diagram illustrating a stitching coupler for waveguide alignment in an optical interposer according to an embodiment of the present invention.

FIG. 6 is a schematic diagram illustrating an evanescent wave coupler for connecting waveguides in different layers within a photonic integrated circuit chip according to an embodiment of the present invention.

FIG. 7 is a schematic diagram illustrating an evanescent wave coupler for connecting a waveguide of a photonic integrated circuit chip to a waveguide of an optical interposer according to an embodiment of the present invention.

FIG. 8 is a schematic diagram illustrating a topology for interconnecting digital electrical chips in another semiconductor structure according to the present invention.

FIG. 9 is a cross-sectional view of yet another semiconductor structure according to the present invention.

### DETAILED DESCRIPTION OF THE INVENTION

Hereinafter, exemplary embodiments will be described in greater detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated. Further, features or aspects within each example embodiment should typically be considered as available for other similar features or aspects in other example embodiments.

Certain terminology may be used in the following description for the purpose of reference only, and thus are not intended to be limiting. For example, terms such as “top”, “bottom”, “upper”, “lower”, “above”, and “below” could be used to refer to directions in the drawings to which reference is made. Terms such as “front”, “back”, “rear”, “side”, “outboard”, and “inboard” could be used to describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

It will be understood that when an element or feature is referred to as being “on,” “connected to,” or “coupled to” another element or layer, it can be directly on, connected to, or coupled to the other element or feature, or one or more intervening elements or features may be present. In addition, it will also be understood that when an element or features is referred to as being “between” two elements or features, it can be the only element or feature between the two elements or features, or one or more intervening elements or features may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

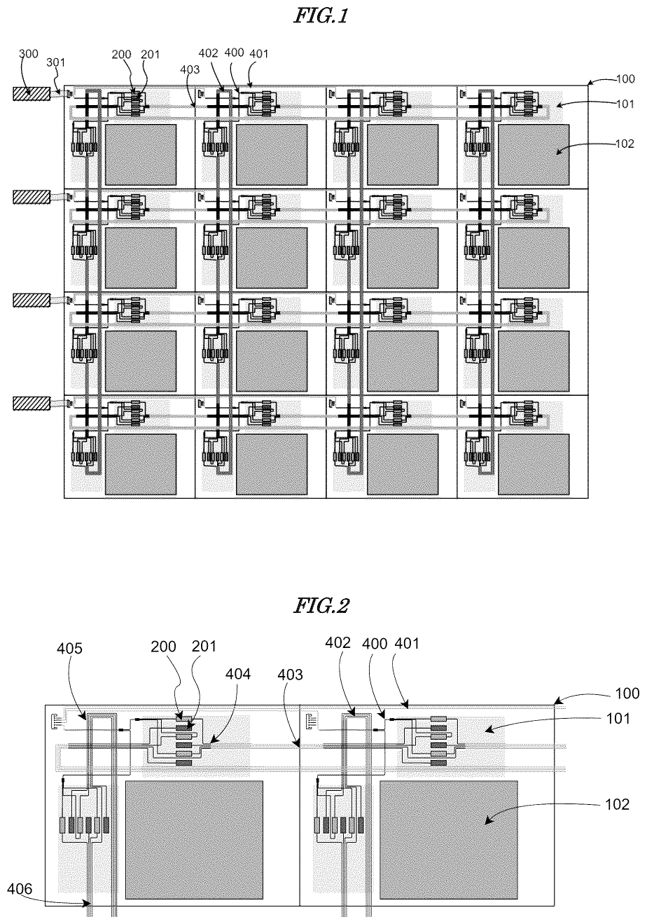

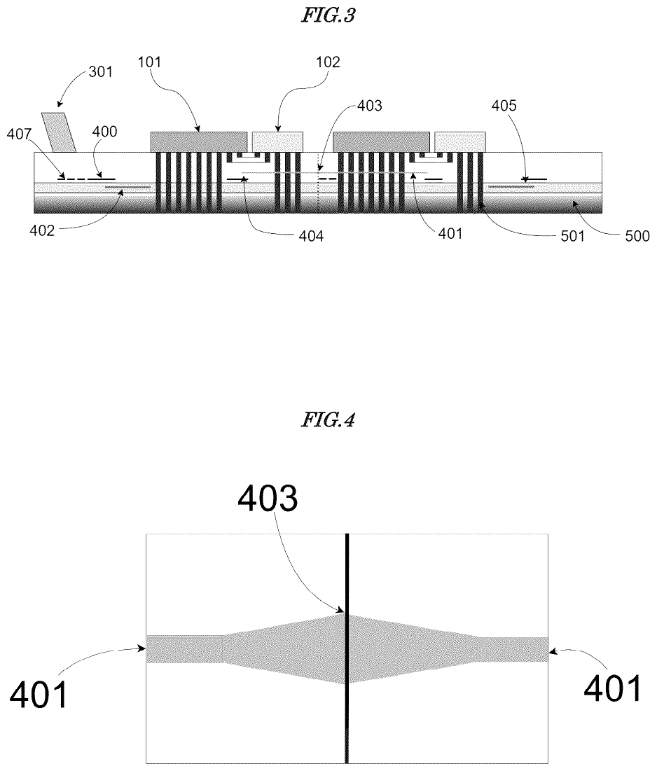

FIG. 1 shows a plan view layout of a semiconductor structure according to an embodiment of the present invention. FIG. 2 shows a partial enlargement of the plan structure of the semiconductor structure shown in FIG. 1. FIG. 3 shows a partial package structure of the semiconductor structure shown in FIG. 1. In the exemplary embodiment shown in FIGS. 1 to 3, the semiconductor structure includes at least a plurality of photonic integrated circuit (PIC) chips 100, a plurality of analog electrical chips 101, a plurality of digital electrical chips 102, and an optical interposer 500.

In this embodiment, the plurality of PIC chips 100 are formed on a photonic wafer. The photonic wafer is mounted on the optical interposer 500, thereby disposing the plurality of PIC chips 100 on the optical interposer 500. The plurality of PIC chips 100 are arranged along a first direction and a second direction, the first direction being different from the second direction. For example, as shown in FIG. 1, sixteen PIC chips 100 are arranged in a 4×4 matrix. The first direction may correspond to the row direction, while the second direction may correspond to the column direction. In alternative embodiments, the number of PIC chips can be less than or more than sixteen, and can be arranged in any N×M configuration depending on the intended application and functionality of the semiconductor structure.

In the exemplary embodiment, each PIC chip 100 includes waveguides 400, waveguides 401 formed on a different layer from waveguides 400, and communication nodes for electro-optical and opto-electrical conversion. The communication nodes include a modulator or modulator array 200 and a detector or detector array 201. In alternative embodiments, the communication nodes may include electro-optical conversion modules and opto-electrical conversion modules, or other photonic transceiver devices. In an exemplary embodiment, in the first direction, the waveguides 401 of two adjacent PIC chips 100 are optically coupled by alignment through stitching couplers 403, thereby establishing optical communication between adjacent PIC chips. As shown in FIG. 4, the stitching coupler 403 includes a structure where the end of the waveguide 401 gradually expands towards the edge of the PIC chip. This enlarges the contact area at the waveguide end, expands the optical mode field, increases the alignment tolerance at the connection point of adjacent waveguides on the same layer, and improves coupling efficiency.

In an exemplary embodiment, the optical interposer 500 may comprise a plurality of optical interposer modules, each optical interposer module comprising a waveguide 402 formed therein. In the second direction, the waveguides 402 of adjacent optical interposer modules are optically coupled by alignment through stitching couplers 405. As shown in FIG. 5, each stitching coupler 405 includes a structure where the end of the waveguide 402 gradually expands towards the edge of the optical interposer module. This enlarges the contact area at the waveguide end, expands the optical mode field, increases the alignment tolerance at the connection point of adjacent waveguides on the same layer, and improves coupling efficiency.

According to the above structure, waveguides on the same layer are interconnected only in one direction. For example, the waveguides 401 of adjacent PIC chips are optically connected along the first direction, while the waveguides 402 of adjacent optical interposer modules are optically connected along the second direction. This configuration avoids cross-connections of waveguides on the same layer, thereby reducing optical power loss caused by such crossings. Moreover, as the waveguides 401 and 402 can be formed separately, the number of masks required is greatly reduced, enabling the fabrication of ultra-large-scale, fully-connected optoelectronic computing systems.

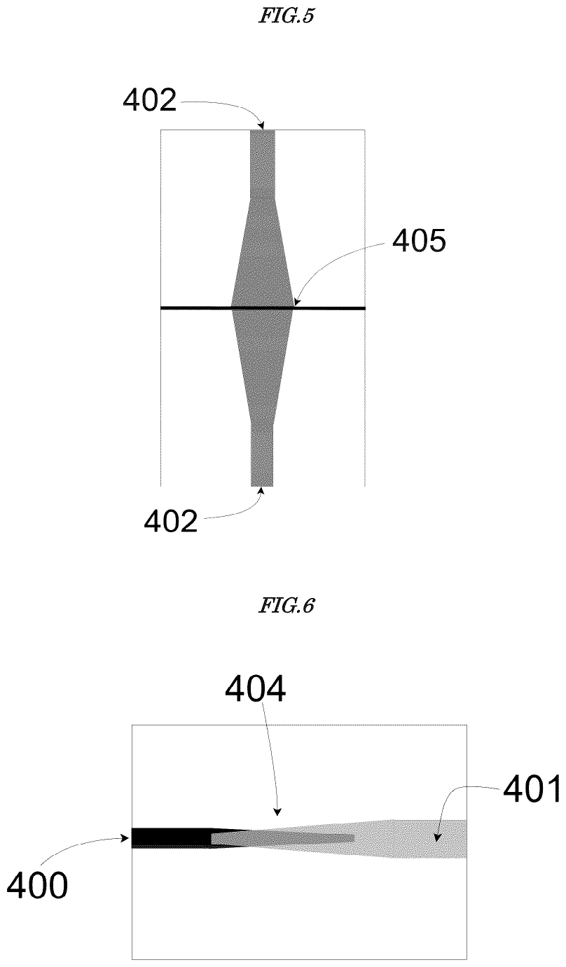

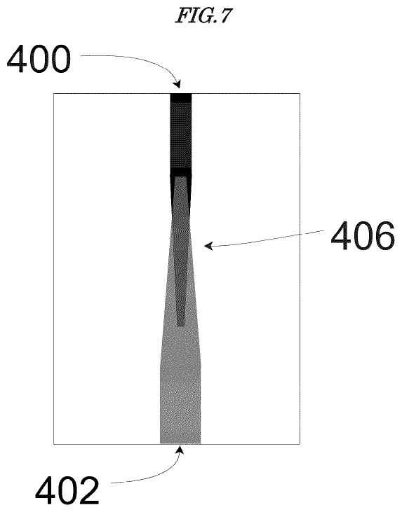

In an exemplary embodiment, the waveguide 400 in the PIC chip 100 optically connects the modulator or modulator array 200 and the detector or detector array 201 to the waveguides 401 and 402, respectively. As shown in FIG. 6, the waveguide 400 is optically coupled to the waveguide 401 via an evanescent wave coupler 404. As shown in FIG. 7, the waveguide 400 is optically coupled to the waveguide 402 via an evanescent wave coupler 406. In some embodiments, the waveguide 400 comprises a silicon waveguide, the waveguide 401 comprises a silicon nitride waveguide, and the waveguide 402 comprises a silicon nitride waveguide. The stitching couplers 403, 405 comprise silicon nitride waveguide stitching couplers, while the evanescent wave couplers 404, 406 comprise silicon-to-silicon nitride evanescent wave couplers.

As shown in FIG. 3, each PIC chip 100 further includes a grating coupler 407. The grating coupler 407 is optically connected to the modulator or modulator array 200 via another waveguide 401 configured to input optical signals. In an exemplary embodiment, as shown in FIG. 1, the grating coupler (as shown in FIG. 3) of one PIC chip (e.g., the first or last PIC chip in the row direction) in each row of PIC chips is optically connected to an external laser module 300 via a fiber array 301. In this way, optical signals generated by the external laser module 300 are delivered to the modulator or modulator array 200. In an alternative embodiment, the PIC chip may further include a beam splitter (not shown) configured to distribute the optical signal coupled in by the grating coupler 407 to different modulators or modulator arrays 200. In an alternative embodiment, instead of using a grating coupler, an edge coupler may be used to couple optical signals provided by an external light source into the PIC ship. In an alternative embodiment, a laser module may be directly mounted on the PIC chip, thereby eliminating the need to use a fiber array to transmit optical signals.

The communication node of each PIC chip 100 may be connected to at least one analog electrical chip 101, and each analog electrical chip 101 may be connected to a corresponding digital electrical chip 102. In an exemplary embodiment, as shown in FIG. 2, two analog electrical chips 101 are disposed above two respective communication nodes on a single PIC chip 100, and one digital electrical chip 102 is disposed adjacent to the analog electrical chips 101. This digital electrical chip 102 is electrically connected to the corresponding two analog electrical chips 101 via wiring structures (e.g., metal traces) formed within the corresponding PIC chip. In alternative embodiments, at least one of the analog electrical chips and digital electrical chips may be disposed on the optical interposer or on a substrate outside the PIC chip. In alternative embodiments, one or more than two analog electrical chips or digital electrical chips may be disposed on one PIC chip, and the present invention is not limited in this regard.

According to this arrangement, digital electrical chips 102 in the first direction (row direction) can achieve direct point-to-point communication via the corresponding analog electrical chips 101 and the waveguides 401 in the PIC chips 100. Similarly, digital electrical chips 102 in the second direction (column direction) can achieve direct point-to-point communication via the corresponding analog electrical chips 101 and the waveguides 402 in the optical interposer 500. For two digital electrical chips arranged in different rows and columns, communication is achieved via a relay chip. Specifically, the transmitting digital electrical chip first communicates with a digital electrical chip in the same row or column (the relay chip), and this relay chip then communicates with the target receiving digital electrical chip. In this way, full connectivity among any two digital electrical chips within an ultra-large-scale chip array can be achieved with at most two conversion steps. This arrangement, significantly reduces waveguide crossing points on the same layer, thereby minimizing optical power loss caused by such crossings. Furthermore, as the waveguides on the PIC chips and the waveguides in the optical interposer can be formed separately, the number of masks required is greatly reduced, facilitating the manufacture of ultra-large-scale, fully-connected optoelectronic computing systems.

In an exemplary embodiment, the optical signals generated by the external laser module 300 are coupled into the PIC chip 100 via the fiber array 301 and grating coupler 407, and transmitted to the modulator or modulator array 200 via the waveguide 401 for inputting optical signal and the waveguide 400. In an exemplary embodiment, the low-speed parallel signals (i.e., digital information) sent by the transmitting digital electrical chip 102 are converted into high-speed serial signals via a chip interconnect interface (digital-to-analog conversion) and transmitted to the corresponding analog electrical chip 101 through the wiring structures (e.g., metal traces) of the PIC chip. The analog electrical chip 101 generates electrical signals for modulating the optical signals based on the received high-speed serial signals. The modulator or modulator array 200 modulates the input optical signals based on the electrical signals from the analog electrical chip, thereby modulating the information carried by the electrical signals onto the optical signals. The modulated optical signals from the modulator or modulator array 200 can be transmitted via waveguides 400 and 401 to the detector or detector array 201 at the receiving end arranged in the row direction, or via waveguides 400 and 402 to the detector or detector array 201 at the receiving end arranged in the column direction. The detector or detector array 201 converts the received optical signals into analog electrical signals through photoelectric conversion and transmits them to the corresponding receiving analog electrical chip 101. The receiving analog electrical chip 101 transmits the received electrical signals to the corresponding receiving digital electrical chip 102 via a chip interconnect interface, which converts the serial signals back into parallel signals (analog-to-digital conversion). In this manner, communication between the transmitting digital electrical chip and the receiving digital electrical chip is achieved.

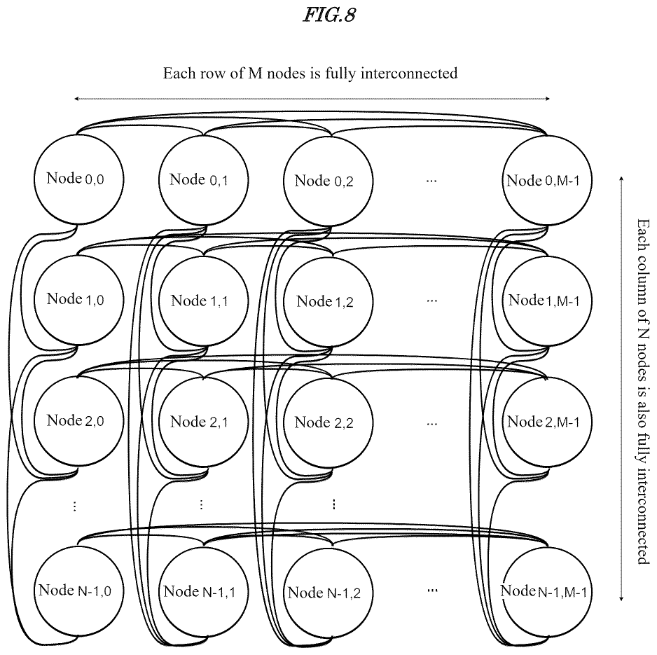

It should be understood that the present invention is not limited to the above exemplary embodiments. The aforementioned PIC chips and optical interposer can be extended to enable communication among additional digital electrical chips. For example, FIG. 8 shows a topology of N×M digital electrical chips in a semiconductor structure according to another embodiment of the invention. In FIG. 8, nodes (0,0) to (N-1, M-1) represent digital electrical chips for transmitting and receiving information, respectively. As shown in FIG. 8, in each row direction, the nodes are directly connected pairwise for communication; in each column direction, the nodes are also directly connected pairwise for communication; for two nodes in different rows and different columns, communication can be achieved with at most one relay node. For example, communication between node (0,0) and node (N-1, M-1) can be achieved via relay node (N-1,0) or node (0, M-1).

In other embodiments of the present invention, the semiconductor structure may further include a substrate that supports the optical interposer, thereby preventing warping and fragmentation of the optical interposer and the photonic wafer. To accommodate large-scale operations, effective heat dissipation for the semiconductor structure is necessary. Therefore, in some embodiments, the semiconductor structure may further integrate appropriate heat dissipation or cooling devices.

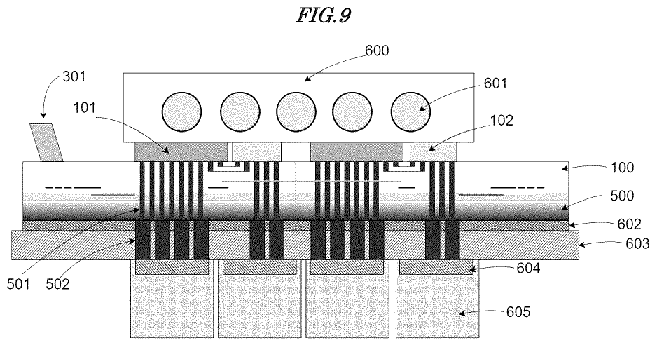

FIG. 9 shows a semiconductor structure according to yet another embodiment of the present invention. In addition to the structures described in the foregoing embodiments, the semiconductor structure further includes a substrate 602, a printed circuit board (PCB) 603, a plurality of vertical power supply devices (including power regulators 604 and vertical power supply modules 605), and a vertical cooling device (including a liquid cooling plate 600 and a cooling fluid 601). In alternative embodiments, other known power supply devices and cooling devices may be used as the power supply and cooling system for the semiconductor structure.

As shown in FIG. 9, the photonic interposer 500 is mounted on the substrate 602, which is in turn mounted on a first surface of the printed circuit board (PCB) 603. On the second surface of the PCB 603, opposite to the first surface, multiple vertical power supply devices are installed. These devices are positioned on the second surface so as to vertically correspond to the analog chips 101 and digital chips 102. Each vertical power supply device is electrically connected to its corresponding analog or digital chip via the metal traces 502 of the PCB, together with conductive structures (e.g., through-silicon vias, TSVs) 501 formed in the photonic interposer and the photonic integrated circuit chips. If traditional lateral power delivery is used, areas closer to the voltage source have shorter conductive paths, leading to smaller voltage drop and relatively higher actual voltage. In contrast, areas farther from the voltage source, such as the center of the interposer, require longer conductive paths, resulting in greater voltage drop and lower effective voltage. Although the voltage source provides the same nominal voltage, the excessive voltage drop at distant locations causes the actual operating voltage to fall below the required level, which undermines the stable operation of semiconductor devices. In this embodiment, a series of power regulators 604 and vertical power supply modules 605 are distributed directly beneath the PCB 603, so that voltage is applied to the chips on the interposer without being routed through traces of varying lengths from the edge of the interposer, resulting in very low and uniform voltage drop across all locations.

In this embodiment, the vertical cooling device is disposed above the plurality of analog electrical chips 101 and the plurality of digital electrical chips 102. The liquid cooling plate 600 of the vertical cooling device is in contact with the surfaces of the analog and digital electrical chips. The liquid cooling plate 600 has a plurality of cooling channels oriented perpendicular to the surfaces of the analog and digital electrical chips, containing the cooling fluid 601. This configuration enables faster heat dissipation with good uniformity of cooling. Therefore, even when the package structure of the present invention is applied to ultra-large-scale optoelectronic computing systems, the heat dissipation requirements can be met.

Furthermore, an embodiment of the present invention provides a method for manufacturing a semiconductor structure, comprising:
providing a photonic wafer comprising a plurality of photonic integrated circuit (PIC) chips, each PIC chip including a first waveguide;
providing an optical interposer, and mounting the photonic wafer on the optical interposer thereon, thereby disposing the plurality of PIC chips on the optical interposer, the optical interposer including a second waveguide;
providing a plurality of analog electrical chips, each PIC chip being connected to at least one of the analog electrical chips such that the plurality of analog electrical chips are enabled to optically communicate with each other via the PIC chips and/or the optical interposer;
providing a plurality of digital electrical chips, each digital electrical chip being electrically connected to a corresponding analog electrical chip such that the plurality of digital electrical chips are enabled to communicate with each other via the analog electrical chips through the PIC chips and/or the optical interposer.

Wherein, on the optical interposer, PIC chips arranged in a first direction are optically connected through the first waveguides, and PIC chips arranged in a second direction are optically connected through the second waveguides, the first direction being different from the second direction.

In some embodiments, the first direction corresponds to arow direction, and the second direction corresponds to a column direction. Communication between two digital electrical chips in the same row can be achieved solely through the first waveguides on the PIC chips. Communication between two digital electrical chips in the same column can be achieved solely through the second waveguides on the optical interposer. Communication between two digital electrical chips in different rows and different columns is achieved using both the first waveguides on the PIC chips and the second waveguides on the optical interposer. In other embodiments, according to predetermined routing rules, communication between two digital electrical chips in the same row or in the same column may also be achieved by using both the first waveguides on the PIC chips and the second waveguides on the optical interposer.

In some embodiments, the PIC chips are fabricated by exposure using a full-mask reticle.

In some embodiments of the present invention, each PIC chip comprises a stitching coupler oriented along the first direction. In the first direction, the first waveguides of two adjacent PIC chips are aligned via stitching couplers. In some embodiments, the coupling end of the stitching coupler on the PIC chip is structured to gradually expand towards the edge of the PIC chip.

In some embodiments, the optical interposer comprises a plurality of optical interposer modules, each fabricated by exposure using a full-mask reticle. In some embodiments, each optical interposer module comprises a stitching coupler oriented along the second direction. In the second direction, the second waveguides of two adjacent optical interposer modules are aligned via stitching couplers. In some embodiments, the coupling end of the stitching coupler on the optical interposer module is structured to gradually expand towards the edge of the optical interposer module.

In some embodiments, each PIC chip comprises a communication node for communicating with a corresponding analog electrical chip. The communication node comprises an electro-optical conversion module and an opto-electrical conversion module.

In some embodiments, each PIC chip further comprises a third waveguide for optical communication. The third waveguide optically connects the electro-optical conversion module and the opto-electrical conversion module to the first and second waveguides. In some embodiments, the third waveguide is optically coupled to the first and second waveguides, respectively, via an evanescent wave coupler.

In some embodiments, two of the analog electrical chips and one of the digital electrical chips are disposed on each PIC chip, the digital electrical chip being electrically connected to the two analog electrical chips.

In some embodiments, the manufacturing method further comprises providing a substrate and mounting the optical interposer on the substrate.

In some embodiments, the manufacturing method further comprises providing a printed circuit board (PCB) and a plurality of vertical power supply devices. The PCB has a first surface and an opposite second surface. The substrate is mounted on the first surface, and the plurality of vertical power supply devices are mounted on the second surface. Each vertical power supply device is located at a position on the second surface vertically corresponding to one of the analog electrical chips or digital electrical chips, and electrically connected to the corresponding chip via PCB metal traces and conductive structures formed in through-holes of the optical interposer and the PIC chips.

In some embodiments, the manufacturing method further comprises providing a vertical cooling device disposed above the plurality of analog electrical chips and the plurality of digital electrical chips. In some embodiments, the vertical cooling device comprises a liquid cooling plate in contact with the surfaces of the analog electrical chips and the digital electrical chips. The liquid cooling plate has a plurality of cooling channels oriented perpendicular to the surfaces of the analog electrical chips and the digital electrical chips, and a cooling fluid contained within the cooling channels.

If the horizontal and vertical waveguides were placed on the same layer, achieving ultra-large-scale full connectivity would require a vast number of masks, and the lithography process would be extremely complex. Furthermore, optical loss at the waveguide crossings in such a configuration would be significant, rendering the approach impractical in both manufacturing and operation. Therefore, in the embodiments of the present invention, two layers of waveguides (e.g., silicon nitride waveguides), formed respectively on the photonic integrated circuit chip (e.g., a silicon-based PIC) and on the optical interposer, are patterned using their own dedicated full-mask reticles. This arrangement drastically reduces the number of masks required, enabling ultra-large-scale full interconnection. By employing two separate silicon nitride waveguide layers, one for horizontal and the other for vertical optical interconnects, same-layer waveguide crossings, thereby reducing the optical power loss associated with such crossings.

Moreover, each digital chip is fully interconnected in both horizontal and vertical directions (as shown in FIG. 8) through adjacent analog electrical chips and the silicon-based PIC, undergoing digital-to-analog, electro-optic, opto-electric, and analog-to-digital conversions in the process. Between any two digital chips, independent data transmission channels are established in both horizontal and vertical directions. This eliminates competition and conflict between channels, ensures low signal latency, and supports high information throughput.

It should be understood by those skilled in the art that the embodiments disclosed above are provided for illustrative purposes only and are not intended to limit the scope of the present invention. Any equivalent modifications or variations made in accordance with the spirit of the invention shall still fall within the scope of the claims of the present invention.

1-30. (canceled)

31. A semiconductor structure, comprising:
a photonic wafer comprising a plurality of photonic integrated circuit (PIC) chips, each PIC chip including a first waveguide;
an optical interposer on which the photonic wafer is mounted, the optical interposer including a second waveguide;
a plurality of analog electrical chips, each PIC chip being connected to at least one of the analog electrical chips such that the plurality of analog electrical chips are enabled to optically communicate with each other via the PIC chips and/or the optical interposer; and
a plurality of digital electrical chips, each digital electrical chip being electrically connected to a corresponding analog electrical chip such that the plurality of digital electrical chips are enabled to communicate with each other via the analog electrical chips through the PIC chips and/or the optical interposer;
wherein, PIC chips arranged in a first direction are optically connected through the first waveguides, and PIC chips arranged in a second direction are optically connected through the second waveguide of the optical interposer, the first direction being different from the second direction.

32. The semiconductor structure according to claim 31, wherein the PIC chips are fabricated by exposure using a full-mask reticle.

33. The semiconductor structure according to claim 31, wherein each PIC chip comprises a stitching coupler oriented along the first direction;
wherein the first waveguides of two adjacent PIC chips in the first direction are aligned via the stitching coupler.

34. The semiconductor structure according to claim 31, wherein the optical interposer comprises a plurality of optical interposer modules, each optical interposer module being fabricated by exposure using a full-mask reticle.

35. The semiconductor structure according to claim 34, wherein each optical interposer module comprises a stitching coupler oriented along the second direction;
wherein the second waveguides of two adjacent optical interposer modules in the second direction are aligned via the stitching coupler.

36. The semiconductor structure according to claim 33, wherein each stitching coupler includes a coupling end that is structured to gradually expand toward the edge of the PIC chip or optical interposer module.

37. The semiconductor structure according to claim 31, wherein each PIC chip comprises a communication node for communicating with a corresponding analog electrical chip, the communication node comprising an electro-optical conversion module and an opto-electrical conversion module.

38. The semiconductor structure according to claim 37, wherein the electro-optical conversion module comprises a modulator or a modulator array configured to modulate information carried by electrical signals from the analog electrical chip onto optical signals transmitted via the PIC chip; and
the opto-electrical conversion module comprises a detector or a detector array, configured to convert optical signals from the PIC chip into electrical signals to be transmitted to the analog electrical chip.

39. The semiconductor structure according to claim 38, wherein each PIC chip further comprises a grating coupler or an edge coupler;
wherein the grating coupler or edge coupler is optically connected to the modulator or modulator array of the plurality of PIC chips arranged in the first direction via the first waveguide, so as to couple optical signals generated by an external laser module into the plurality of PIC chips.

40. The semiconductor structure according to claim 39, wherein each PIC chip further comprises a third waveguide for optical communication, the third waveguide optically connecting the electro-optical conversion module and the opto-electrical conversion module to the first and second waveguides.

41. The semiconductor structure according to claim 31, wherein two of the analog electrical chips and one of the digital electrical chips are disposed on each PIC chip, the digital electrical chip being electrically connected to the two analog electrical chips.

42. The semiconductor structure according to claim 41, further comprising:
a substrate on which the optical interposer is mounted;
a printed circuit board (PCB) having a first surface and an opposite second surface, the substrate being mounted on the first surface; and
a plurality of vertical power supply devices which is mounted on the second surface of the PCB;
wherein each vertical power supply device is located at a position on the second surface vertically corresponding to one of the analog electrical chips or digital electrical chips, and electrically connected to the corresponding chip via PCB metal traces and conductive structures formed in through-holes of the optical interposer and the PIC chips.

43. The semiconductor structure according to claim 41, further comprising a vertical cooling device disposed above the plurality of analog electrical chips and the plurality of digital electrical chips.

44. The semiconductor structure according to claim 43, wherein the vertical cooling device comprises a liquid cooling plate in contact with the surfaces of the analog electrical chips and the digital electrical chips;
wherein the liquid cooling plate comprises a plurality of cooling channels oriented perpendicular to the surfaces of the analog electrical chips and the digital electrical chips, and a cooling fluid accommodated in the cooling channels.

45. A method for manufacturing a semiconductor structure, comprising:
providing a photonic wafer comprising a plurality of photonic integrated circuit (PIC) chips, each PIC chip including a first waveguide;
providing an optical interposer on which the photonic wafer is disposed, the optical interposer including a second waveguide;
providing a plurality of analog electrical chips, each PIC chip being connected to at least one of the analog electrical chips such that the plurality of analog electrical chips are enabled to optically communicate with each other via the PIC chips and/or the optical interposer; and
providing a plurality of digital electrical chips, each digital electrical chip being electrically connected to a corresponding analog electrical chip such that the plurality of digital electrical chips are enabled to communicate with each other via the analog electrical chips through the PIC chips and/or the optical interposer;
wherein, PIC chips arranged in a first direction are optically connected through the first waveguides, and PIC chips arranged in a second direction are optically connected through the second waveguides, the first direction being different from the second direction.

46. The method according to claim 45, wherein the PIC chips are fabricated by exposure using a full-mask reticle.

47. The method according to claim 46, wherein each PIC chip comprises a stitching coupler oriented along the first direction;
wherein the first waveguides of two adjacent PIC chips in the first direction are aligned via the stitching coupler.

48. The method according to claim 45, wherein the optical interposer comprises a plurality of optical interposer modules, each optical interposer module being fabricated by exposure using a full-mask reticle.

49. The method according to claim 48, wherein each optical interposer module comprises a stitching coupler oriented along the second direction;
wherein the second waveguides of two adjacent optical interposer modules in the second direction are aligned via the stitching coupler.

50. The method according to claim 47, wherein the stitching coupler includes a coupling end that is structured to gradually expand toward the edge of the PIC chip or optical interposer module.

51. The method according to claim 45, wherein each PIC chip comprises a communication node for communicating with a corresponding analog electrical chip, the communication node comprising an electro-optical conversion module and an opto-electrical conversion module.

52. The method according to claim 51, wherein each PIC chip further comprises a third waveguide for optical communication, the third waveguide optically connecting the electro-optical conversion module and the opto-electrical conversion module to the first and second waveguides.

53. The method according to claim 45, wherein two of the analog electrical chips and one of the digital electrical chips are disposed on each PIC chip, the digital electrical chip being electrically connected to the two analog electrical chips.

54. The method according to claim 53, further comprising:
providing a substrate and mounting the optical interposer on the substrate; and
providing a printed circuit board (PCB) and a plurality of vertical power supply devices;
wherein the PCB has a first surface and an opposite second surface, the substrate being mounted on the first surface, and the plurality of vertical power supply devices being mounted on the second surface;
wherein each vertical power supply device is located at a position on the second surface vertically corresponding to one of the analog electrical chips or digital electrical chips, and electrically connected to the corresponding chip via PCB metal traces and conductive structures formed in through-holes of the optical interposer and the PIC chips.

55. The method according to claim 53, further comprising providing a vertical cooling device and disposing the vertical cooling device above the plurality of analog electrical chips and the plurality of digital electrical chips.

56. The method according to claim 55, wherein the vertical cooling device comprises a liquid cooling plate in contact with the surfaces of the analog electrical chips and the digital electrical chips;
wherein the liquid cooling plate comprises a plurality of cooling channels oriented perpendicular to the surfaces of the analog electrical chips and the digital electrical chips, and a cooling fluid accommodated in the cooling channels.
